(19) United States
(12) Patent Application Publication
(10) Pub. No.: US 2024/0336427 A1
(43) Pub. Date: Oct. 10, 2024

(54) SEALING DEVICE, GARBAGE CAN BODY AND GARBAGE CAN

(71) Applicant: Huanjiu LU, Jiangmen, Guangdong (CN)

(72) Inventors: Jinsheng LIAO, Jiangmen, Guangdong (CN); Huanjiu LU, Jiangmen, Guangdong (CN)

(21) Appl. No.: 18/576,040

(22) PCT Filed: Dec. 13, 2021
(86) PCT No.: PCT/CN2021/137395

§ 371 Date: Jan. 2, 2024

(30) Foreign Application Priority Data
Nov. 8, 2021 (CN) 202122726574.5

(51) Int. Cl. B65F 1/06; B65F 1/16

(52) U.S. Cl. CPC B65F 1/06; B65F 1/1638; B65F 2001/1676

(57) ABSTRACT

A sealing device and a garbage can with the sealing device are disclosed. The sealing device includes: a connecting assembly, provided with a limiting piece; a ring pressing assembly, including a first ring pressing piece and a second ring pressing piece, and configured for arranging a pull-rope-type garbage bag; the ring pressing assembly being rotatably connected with the connecting assembly; the first ring pressing piece and the second ring pressing piece being configured to rotate from a first position to a second position under an action of a pull rope of the pull-rope-type garbage bag, and the first ring pressing piece and the second ring pressing piece being both provided with a round corner at a side opposite to a rope pulling direction; and the limiting piece, arranged on the connecting assembly, and configured for limiting a rotatable angle of the ring pressing assembly.

### CROSS-REFERENCE TO RELATED APPLICATIONS

This application is a national stage filing under 35 U.S.C. § 371 of international application number PCT/CN2021/137395, filed Dec. 13, 2021, which claims priority to Chinese patent application No. 2021227265745 filed Nov. 8, 2021. The contents of these applications are incorporated herein by reference in their entirety.

### TECHNICAL FIELD

The present disclosure refers to the field of articles of daily use, and in particular to a sealing device, a garbage can body and a garbage can.

### BACKGROUND

Garbage can is a common article of daily use in a family, which is configured for temporarily storing garbage. After the garbage is full, the garbage needs to be cleaned up in time. However, in a process of cleaning up the garbage, improper handling of excessive garbage may cause the garbage to be scattered, and a user needs to collect and clean the garbage again, causing inconvenience to the user. In the related technology, the combination of nested inner and outer can bodies is configured for a garbage can to fasten a garbage bag. When cleaning up the garbage, it is necessary to separate the inner can body and the outer can body to remove the garbage bag. The production of the garbage can consumes materials, and it is not easy for the user to sort out the garbage bag when cleaning up the garbage, which may get hands of the user dirty, resulting in poor user experience.

### SUMMARY

The present disclosure aims at solving at least one of the technical problems in the existing technology. For this purpose, the present disclosure provides a sealing device, a garbage can body and a garbage can, which allows a user to pack and seal the garbage, and rearrange the garbage bag more conveniently when cleaning up the garbage, reducing the likelihood of the bag falling off naturally due to the weight of the garbage, minimizing the probability of dirtying hands, and improving the user experience.

According to an embodiment in a first aspect of the present disclosure, a sealing device applied to a garbage can, includes:
a connecting assembly, provided with a limiting piece;
a ring pressing assembly, including a first ring pressing piece and a second ring pressing piece, and configured for arranging a pull-rope-type garbage bag;
the ring pressing assembly being rotatably connected with the connecting assembly; the first ring pressing piece and the second ring pressing piece being configured to rotate from a first position to a second position under an action of a pull rope of the pull-rope-type garbage bag, and the first ring pressing piece and the second ring pressing piece being both provided with a round corner at a side opposite to a rope pulling direction; and
the limiting piece, arranged on the connecting assembly, and configured for limiting a rotatable angle of the ring pressing assembly.

The sealing device according to the embodiment of the present disclosure at least has the following beneficial effects.

The ring pressing assembly is rotatably connected with the connecting assembly, so that the user can conveniently and quickly place and put away the pull-rope-type garbage bag by rotating the ring pressing assembly. The limiting piece enables the first ring pressing piece and the second ring pressing piece to rotate between the first position and the second position. When the first ring pressing piece and the second ring pressing piece rotate from the first position to the second position, the pull-rope-type garbage bag is closed upwards to complete sealing. The first ring pressing piece and the second ring pressing piece are both provided with a round corner at a side opposite to a rope pulling direction. Due to the round corner, the pull-rope-type garbage bag is separated from the ring pressing assembly more smoothly and conveniently under traction of the pull rope, so that the risk of breakage of the pull-rope-type garbage bag during sealing is effectively reduced.

According to some embodiments of the present disclosure, in the first position, the first ring pressing piece and the second ring pressing piece are under an action of the limiting piece, and a plane on which the first ring pressing piece is located and a plane on which the second ring pressing piece is located form a dihedral angle of less than 180 degrees.

According to some embodiments of the present disclosure, in the second position, the first ring pressing piece and the second ring pressing piece are under an action of the limiting piece, and a plane on which the first ring pressing piece is located is relatively parallel to a plane on which the second ring pressing piece is located, or a plane on which the first ring pressing piece is located and a plane on which the second ring pressing piece is located form a dihedral angle of less than 90 degrees.

According to some embodiments of the present disclosure, further including an elastic assembly arranged on the connecting assembly, where the elastic assembly is connected with the ring pressing assembly, and the elastic assembly is configured for driving the first ring pressing piece and the second ring pressing piece to rotate from the second position to the first position.

According to some embodiments of the present disclosure, a circular arc of the round corner of the ring pressing assembly is at least R80.

According to some embodiments of the present disclosure, the connecting assembly includes a first connecting piece and a second connecting piece.

According to an embodiment in a second aspect of the present disclosure, the sealing device further includes, in addition to the structure of the sealing device according to the embodiment in the first aspect, the first connecting piece is further provided with a rope clamping portion, the rope clamping portion is provided with a clamping groove, and the clamping groove is configured for threading the pull rope of the pull-rope-type garbage bag.

According to an embodiment in a third aspect of the present disclosure, a garbage can body includes the sealing device according to the embodiment in the second aspect and a first can body connected with the connecting assembly.

According to an embodiment in a fourth aspect of the present disclosure, a garbage can body includes the sealing device according to the embodiment in the first aspect and a second can body connected with the connecting assembly.

According to some embodiments of the present disclosure, in the garbage can body provided by the embodiment in the fourth aspect, a rope clamping portion is arranged on the second can body in a position corresponding to the connecting assembly, the rope clamping portion is provided with a clamping groove, and the clamping groove is configured for threading the pull rope of the pull-rope-type garbage bag.

According to an embodiment in a fifth aspect of the present disclosure, a garbage can includes the garbage can body according to the embodiment in the third aspect, or the garbage can body the embodiment in the fourth aspect.

According to some embodiments of the present disclosure, the garbage can provided by the embodiment in a fifth aspect includes a first can body and a first can cover body movably connected with the first can body, and the garbage can body is arranged in the first can body.

According to some embodiments of the present disclosure, the garbage can provided by the embodiment in a fifth aspect further includes an induction switch device configured for controlling opening and closing of the first can cover body, where the induction switch device includes a driving module connected with the first can cover body, a controller connected with the driving module and a sensor connected with the controller.

According to an embodiment in a sixth aspect of the present disclosure, a garbage can includes the sealing device according to the embodiment in the second aspect.

According to an embodiment in a seventh aspect of the present disclosure, a garbage can includes the sealing device according to the embodiment in the first aspect.

According to some embodiments of the present disclosure, the garbage can according to the embodiment in the seventh aspect further includes a second can body and a second can cover body movably connected with the second can body, the sealing device is arranged on the second can body, a rope clamping portion is arranged on the second can body in a position corresponding to the connecting assembly, the rope clamping portion is provided with a clamping groove, and the clamping groove is configured for threading a pull rope of the pull-rope-type garbage bag.

According to some embodiments of the present disclosure, the garbage can according to the embodiment in the fifth aspect further includes an induction switch device configured for controlling opening and closing of the first can cover body, where the induction switch device includes a driving module connected with the first can cover body, a controller connected with the driving module and a sensor connected with the controller.

The garbage can according to the embodiment in the fifth aspect or the embodiment in the sixth aspect or the embodiment in the seventh aspect of the present disclosure has at least the following beneficial effects.

The sealing device is applied to the garbage can, and an edge of the pull-rope-type garbage bag may be folded along the ring pressing assembly, so that the garbage can is more beautiful. When the pull rope of the pull-rope-type garbage bag is tightened, the sealing device completes the sealing of the pull-rope-type garbage bag under the traction of the pull rope. The use of the sealing device improves a space utilization rate of the garbage can while being convenient for the user to use.

The additional aspects and advantages of the present disclosure will be partially given in the following description, and will be partially apparent from the following description, or will be understood via the practice of the present disclosure.

### BRIEF DESCRIPTION OF THE DRAWINGS

The above and/or additional aspects and advantages of the present disclosure will be more apparent from the following description of the embodiments in conjunction with the accompanying drawings, where:

FIG. 1 is a structural schematic diagram of a sealing device according to an embodiment in a second aspect of the present disclosure;

FIG. 2 is an exploded structural schematic diagram of the sealing device according to the embodiment in the second aspect of the present disclosure:

FIG. 3 is a rear view of the sealing device according to the embodiment in the second aspect of the present disclosure as shown in FIG. 1:

FIG. 4 is a structural schematic diagram of a first ring pressing piece in a ring pressing assembly according to some embodiments of the present disclosure:

FIG. 5 is a partial enlarged diagram of portion A in FIG. 2:

FIG. 6 is a schematic diagram of a sealing state of the sealing device according to the embodiment in the second aspect of the present disclosure:

FIG. 7 is a structural schematic diagram of a garbage can according to an embodiment in a sixth aspect of the present disclosure:

FIG. 8 is a structural schematic diagram of a protective piece according to the embodiment in the sixth aspect of the present disclosure; and

FIG. 9 is a structural schematic diagram of a garbage can according to an embodiment in a seventh aspect of the present disclosure.

### REFERENCE NUMERALS

100 refers to sealing device;
110 refers to ring pressing assembly, 111 refers to first ring pressing piece, 112 refers to second ring pressing piece, 1110 refers to connector, 1111 refers to rotating shaft, 1112 refers to first connecting shaft, 1113 refers to round corner, 1114 refers to second connecting shaft, and 130 refers to support opening;
120 refers to connecting assembly, 121 refers to first connecting piece, 122 refers to second connecting piece, 123 refers to limiting piece, 1231 refers to first stop block, 1232 refers to first groove, 1215 refers to through hole, 124 refers to rope clamping portion, 1241 refers to clamping groove, 125 refers to elastic assembly, 1221 refers to first resetting piece, 1222 refers to second resetting piece, and 1223 refers to mounting piece;
200 refers to first garbage can, 210 refers to opening portion, 220 refers to flange, 230 refers to protective piece, 231 refers to mounting hole, 232 refers to second groove, and 240 refers to can body; and
210 refers to second garbage can, 211 refers to second can body, 212 refers to second can cover body, and 213 refers to induction switch.

### DETAILED DESCRIPTION

The embodiments of the present disclosure will be described in detail hereinafter. Examples of the embodiments are shown in the accompanying drawings. The same or similar reference numerals throughout the drawings denote the same or similar elements or elements having the same or similar functions. The embodiments described below with reference to the accompanying drawings are exemplary and are only intended to explain the present disclosure, but should not be construed as limiting the present disclosure.

In the description of the present disclosure, it should be understood that the orientation or position relation related to the orientation description, such as the orientation or position relation indicated by the upper, lower, front, rear, left, right, etc., is based on the orientation or position relation shown in the drawings, which is only used for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, greater than, less than and exceeding are understood as excluding the following number, and above, below and within are understood as including the following number. If first and second are described, the descriptions are used for the purpose of distinguishing the technical features only, and cannot be understood as indicating or implying relative importance, or implicitly indicating the number of technical features indicated thereby, or implicitly indicating the order of technical features indicated thereby.

In the description of the present disclosure, unless otherwise clearly defined, words such as setting, installation, connection, and the like, shall be understood broadly, and those of ordinary skills in the art can reasonably determine the specific meanings of the above words in the present disclosure in combination with the specific contents of the technical solution.

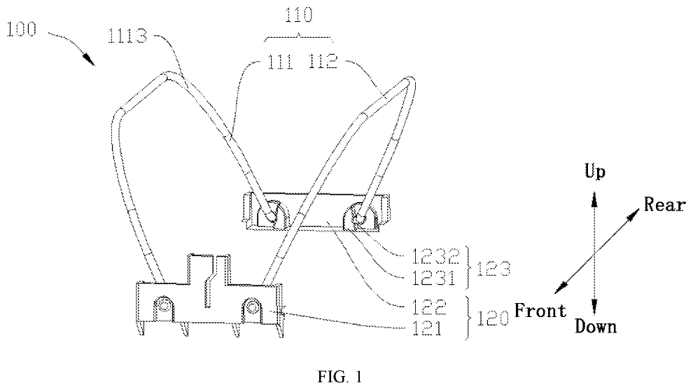

Referring to FIG. 1 to FIG. 3, an embodiment in a second aspect of the present disclosure provides a sealing device 100. It should be noted that the sealing device 100 is arranged in a first garbage can 200 (not shown in the figures). The sealing device 100 includes a connecting assembly 120, provided with a limiting piece 123; a ring pressing assembly 110, provided with a round corner 1113, and including the ring pressing assembly and a second ring pressing piece 112, and configured for arranging a pull-rope-type garbage bag; the ring pressing assembly 110 is rotatably connected with the connecting assembly 120; and the ring pressing assembly and the second ring pressing piece 112 rotate in a circular sector to close towards each other under an action of a pull rope of the pull-rope-type garbage bag, and rotate from a first position to a second position under an interaction with the limiting piece 123. In the first position, the ring pressing assembly 111 and the second ring pressing piece 112 are under the action of the limiting piece 123, and a plane on which the ring pressing assembly is located and a plane on which the second ring pressing piece 112 is located form a dihedral angle α of less than 180 degrees. The limiting piece 123 arranged on the connecting assembly 120 enables the first ring pressing piece 111 and the second ring pressing piece 112 to rotate from the first position to the second position. In the first position, the first ring pressing piece 111 and the second ring pressing piece 112 are inclined opposite to each other under the action of the limiting piece 123 to form a support opening 130 for placing the garbage bag.

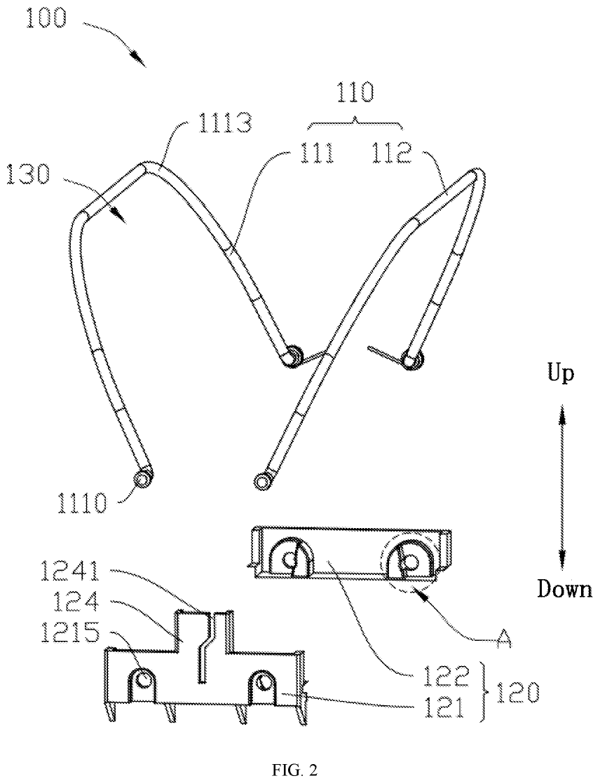

FIG. 2 shows a structural schematic diagram of the sealing device 100 according to the embodiment in the second aspect of the present disclosure.

To be specific, the connecting assembly 120 includes a first connecting piece 121 and a second connecting piece 122 arranged opposite to each other, the first connecting piece 121 and the second connecting piece 122 are provided with through holes 1215, and a connector 1110 of the ring pressing assembly 110 enables the ring pressing assembly 110 and the connecting assembly 120 to connect rotatably via the through hole 1215. The user may conveniently and quickly place and put away the pull-rope-type garbage bag by rotating the ring pressing assembly 110.

To be specific, the second connecting piece 122 is provided with two through holes 1215 corresponding to the first connecting piece 121. Shapes and sizes of the through holes 1215 are matched with the connectors 1110 of the first ring pressing piece 111 and the second ring pressing piece 112. A certain gap exists between the two through holes to ensure that the first ring pressing piece 111 and the second ring pressing piece 112 do not contact when rotating to the second position, leaving a certain gap. A rope clamping portion 124 is arranged between two through holes 1215 of the first connecting piece 121, and the rope clamping portion 124 is provided with a clamping groove 1241. An opening of the clamping groove 1241 meanders from a top to a bottom of the clamping groove 1241 for the pull-rope-type garbage bag.

The ring pressing assembly 110 is rotatably connected with the connecting assembly 120 to realize the opening and closing of the support opening 130. It should be understood that when the first garbage can 200 is placed with a pull-rope-type garbage bag, the pull rope of the pull-rope-type garbage bag is placed in the clamping groove 1241 of the rope clamping portion 124. The rope clamping portion 124 cooperates with the ring pressing assembly 110 in the sealing device 100 to arrange the pull-rope-type garbage bag. When sealing the pull-rope-type garbage bag, the pull-rope-type garbage bag is pulled out relative to the support opening 130 along the clamping groove 1241 to complete a sealing action. In the process of sealing the pull-rope-type garbage bag, the rope clamping portion 124 prevents the pulling rope from easily separating from the first connecting piece 121, which is more convenient for sealing.

It should be noted that the rope clamping portion 124 may be arranged on the connecting assembly 120 of the sealing device 100; the rope clamping portion 124 may also not be arranged on the sealing device 100, but may be arranged on the garbage can body of the garbage can to which the sealing device 100 is applied. Therefore, the present disclosure does not specifically limit a position of the rope clamping portion 124, as long as the rope clamping portion 124 can cooperate with the sealing device 100 to arrange the garbage bag. The sealing device 100 with the rope clamping portion 124 is the embodiment in the second aspect of the present disclosure, and the sealing device 100 without the rope clamping portion 124 is the embodiment in the first aspect of the present disclosure.

It should be noted that a specific structure of the rope clamping portion 124 is not limited in the present disclosure. The rope clamping portion 124 may adopt the clamping groove 1241, and the shape of the clamping groove 1241 may be an inverted Y shape or a continuous Z shape. A buckle structure may also be adopted as the rope clamping portion 124.

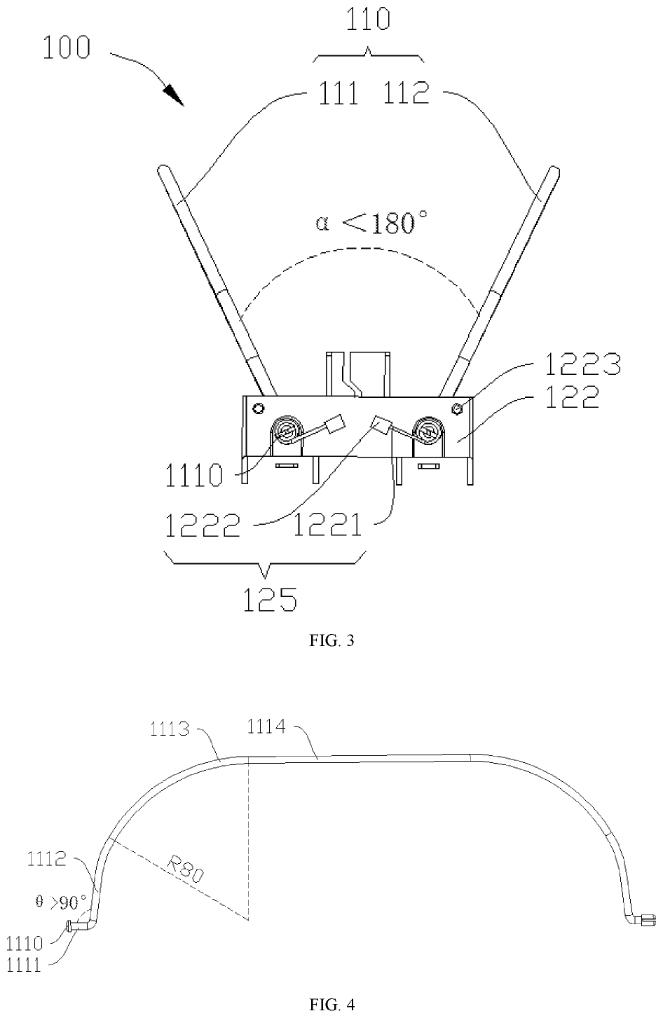

Referring to FIG. 3, when the ring pressing assembly 110 is in the first position, the plane on which the ring pressing assembly 110 is located and the plane on which the second ring pressing piece 112 is located form a dihedral angle α less than 180 degrees. The first position is an initial position of the ring pressing assembly 110 under the action of the limiting piece 123. When the pull rope of the pull-rope-type garbage bag is pulled, under the traction of the pull rope, the ring pressing assembly 110 moves upward and rightward, and the second ring pressing piece 112 moves upward and leftward. The pull-rope-type garbage bag is sealed with the closing of the support opening 130, and may be smoothly separated from the ring pressing assembly 110. In the process of closing and sealing, the support opening 130 still plays a supporting role for the pull-rope-type garbage bag, and sealing may also be completed when the garbage carried by the pull-rope-type garbage bag is heavy.

FIG. 4 shows a structural schematic diagram of the first ring pressing piece 111 in the ring pressing assembly 110 in some embodiments of the present disclosure. The first ring pressing piece 111 at least includes a connector 1110, a rotating shaft 1111, a first connecting shaft 1112, a round corner 1113 and a second connecting shaft 1114. The first connecting shaft 1112 is connected with the rotating shaft 1111 and the round corner 1113, and an angle θ at a joint between the first connecting shaft 1112 and the rotating shaft 1111 is greater than 90 degrees. The first ring pressing piece 111 and the second ring pressing piece 112 are provided with the round corner 1113 at least on the side opposite to a rope pulling direction, and the round corner 1113 is R80. According to the mechanical drawing rules. “the round corner 1113 is R80” means that a radius of an arc of the round corner 1113 is 80 mm.

The round corner 1113 refers to replacing the original corner with an arc tangent to both sides of the corner, and a size of the round corner is expressed by a radius of the arc. A specific shape of the round corner 1113 is determined by the radius of the selected arc and the angle of the arc. To be specific, the degree of arc of the round corner 1113 in the present disclosure is at least 80 mm. It may be understood that the radius of the arc of the round corner 1113 may also be 90 mm, 100 mm, etc. Those of ordinary skills in the art may choose the appropriate arc degree and arc radius to construct the round corner 1113 meeting the actual requirements according to the opening size of the can body of the first garbage can 200 and the actual user's needs.

To be specific, the ring pressing assembly 110 is composed of two connectors 1110, two rotating shafts 1111, two first connecting shafts 1112, at least one round corner 1113 and a second connecting shaft 1114. The connector 1110, the rotating shaft 1111, the first connecting shaft 1112, the round corner 1113 and the second connecting shaft 1114 are connected in sequence. An angle θ at the joint between the first connecting shaft 1112 and the rotating shaft 1111 is greater than 90 degrees. The first ring pressing piece 111 and the second ring pressing piece 112 are formed by splicing of a multi-section structure, showing a smooth linear shape.

It may be understood that the second ring pressing piece 112 should be matched with the first ring pressing piece 111. The first ring pressing piece 111 and the second ring pressing piece 112 are both provided with the round corners 1113 with the same size and shape in the corner positions at a side opposite to the rope pulling direction. The first ring pressing piece 111 and the second ring pressing piece 112 may be rounded, wavy, or polygonal with relaxed edges and corners at a side the same as the rope pulling direction. The arrangement of the round corner 1113 increases the strength of the ring pressing assembly 110. At the same time, the structural features of the first ring pressing piece 111 and the second ring pressing piece 112 enable the pull-rope-type garbage bag to be sealed with the closing of the support opening 130 under the traction of the pull rope, and can be smoothly separated from the ring pressing assembly 110, thus reducing the risk of breakage of the pull-rope-type garbage bag during sealing.

It should be noted that the number of the round corners 1113 on the ring pressing assembly 110 is not specifically limited in the present disclosure. The first ring pressing piece 111 may be provided with one round corner 1113 at a side opposite to the rope pulling direction, while the second ring pressing piece 112 may be also provided with one round corner 1113 at a side opposite to the rope pulling direction corresponding to the first ring pressing piece 111. The first ring pressing piece 111 may also be provided with the round corners 1113 at two turning angles, and correspondingly, the second ring pressing piece 112 may be provided with two round corners 1113, or only be provided with one round corner 1113 at one side opposite to the rope pulling direction.

It should be noted that the connection mode of each structural section in the first ring pressing piece 111 and the second ring pressing piece 112 is not specifically limited in the present disclosure. Each structural section may be connected by welding or in a movable way.

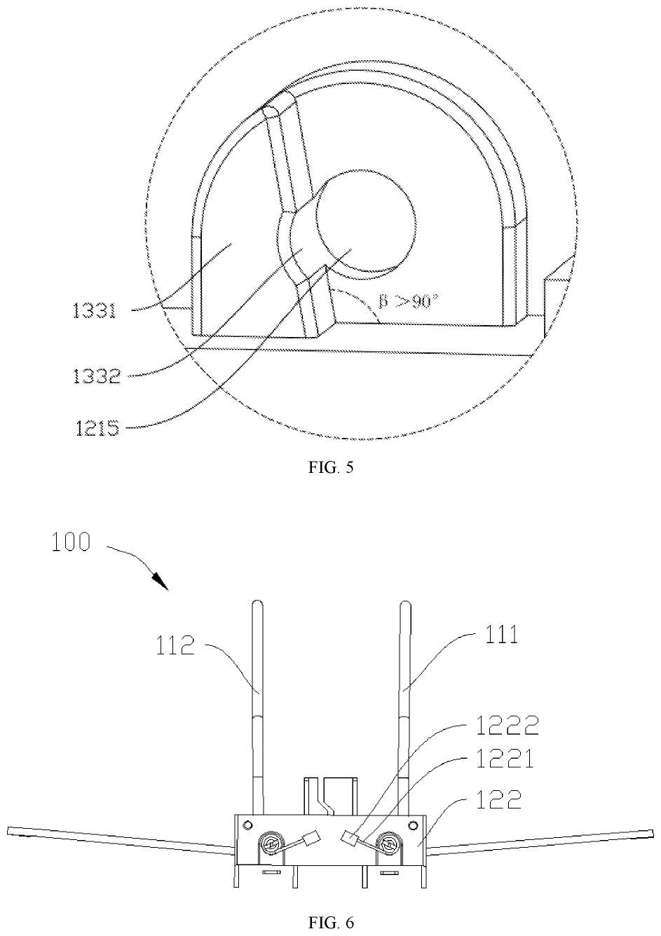

Referring to FIG. 5, the limiting piece 123 includes a first stop block 1231, the first stop block 1231 is provided with a first groove 1232, and the first stop block 1231 is obliquely arranged to form an angle ß greater than 90 degrees with a horizontal ground; and the first groove 1232 interacts with the rotating shaft 1111 to rotate the ring pressing assembly 110. Under the limiting action of the first stop block 1231, the first ring pressing piece 111 and the second ring pressing piece 112 rotate to the second position determined by the first stop block 1231. The limiting piece 123 limits a maximum rotation angle of the first ring pressing piece 111 and the second ring pressing piece 112, leading to a better sealing effect for the garbage bag.

It should be noted that the structure of the limiting piece 123 is not specifically limited in the present disclosure, and the limiting piece 123 may also be composed of gears, magnetic components and other structural pieces.

Referring to FIG. 3, the sealing device 100 further includes an elastic assembly 125 arranged on the connecting assembly 120, and the elastic assembly 125 is connected with the ring pressing assembly 110. The elastic assembly 125 is configured for driving the first ring pressing piece 111 and the second ring pressing piece 112 to rotate from the second position to the first position.

To be specific, the elastic assembly 125 includes a first resetting piece and a second resetting piece, where, the first resetting piece is arranged on the connector 1110 connected with the second connecting piece 122. The second resetting piece 1222 is matched with the first resetting piece 1221 and is arranged on an outer side wall of the second connecting piece 122.

To be specific, when the first resetting piece 1221 is a spring, the second resetting piece 1222 adopts a retaining groove matched with the spring. The retaining groove is arranged obliquely relative to the horizontal ground, which limits the range of movement of the spring, provides a greater force for the resetting of the spring, and also serves to protect the spring to some extent.

To be specific, the angle at which the second resetting piece is obliquely arranged relative to the horizontal ground is matched with the angle at which the limiting piece 123 restricts the rotation of the ring pressing assembly 110. When the first ring pressing piece 111 and the second ring pressing piece 112 rotate to the maximum rotation angle limited by the limiting piece 123, the first resetting piece is abutted against the second resetting piece to generate an interactive force. After the action of the pull rope disappears, the first ring pressing piece 111 and the second ring pressing piece 112 return to the initial first position under the interaction of the first resetting piece and the second resetting piece. The position of the elastic assembly 125 should be determined by the second position limited by the limiting piece 123, so as to ensure that the limiting piece 123 and the elastic assembly 125 cooperate with each other, and the first ring pressing piece 111 and the second ring pressing piece 112 may be limited and reset in the second position.

It should be noted that in this embodiment, the angle and position of the second resetting piece obliquely arranged relative to the horizontal ground in the elastic assembly 125 is not limited specifically, and the angle should be set to match the angle range in which the limiting piece 123 allows the ring pressing assembly 110 to rotate. Those of ordinary skills in the art may choose the configuration of the elastic assembly 125 or determine the configuration of the second resetting piece according to the limiting condition of the limiting piece 123.

FIG. 6 shows a schematic diagram of a sealing state of the sealing device according to the embodiment in the second aspect of the present disclosure. When the sealing device 100 is in the sealing state, the first ring pressing piece 111 and the second ring pressing piece 112 are in the second position. When the first ring pressing piece 111 and the second ring pressing piece 112 rotate to the second position, the first resetting piece 1221 and the second resetting piece 1222 are abutted against each other. When the garbage bag is sealed and separated from the ring pressing assembly 110, the ring pressing assembly 110 will be reset to the first position under the interaction of the first resetting piece 1221 and the second resetting piece 1222. In the second position, the first ring pressing piece 111 and the second ring pressing piece 112 are limited by the limiting piece 123, and the plane on which the first ring pressing piece 111 is located is relatively parallel to the plane on which the second ring pressing piece 112 is located, or the plane on which the first ring pressing piece 111 is located forms a dihedral angle of less than 90 degrees with the plane on which the second ring pressing piece 112 is located. In the second position, the first ring pressing piece 111 and the second ring pressing piece 112 are not in contact with each other, leaving a certain gap. The gap between the first ring pressing piece 111 and the second ring pressing piece 112 makes the sealing process of the pull-rope-type garbage bag smoother.

It should be noted that heights of the first ring pressing piece 111 and the second ring pressing piece 112 should be adapted to a limiting angle limited by the limiting piece 123, so as to ensure that the first ring pressing piece 111 and the second ring pressing piece 112 are not in contact with each other in the second position, leaving a certain gap. In the present disclosure, the heights of the first ring pressing piece 111 and the second ring pressing piece 112 are not specifically limited, and those of ordinary skills in the art may set the heights of the first ring pressing piece 111 and the second ring pressing piece 112 according to the specific limiting angle in the actual situation, as long as the first ring pressing piece 111 and the second ring pressing piece 112 are not in contact with each other in the second position.

Referring to FIG. 2 and FIG. 6, the second connecting piece 122 is provided with two through holes 1215 corresponding to the first connecting piece 121, and a certain gap should exist between the two through holes to ensure that the first ring pressing piece 111 and the second ring pressing piece 112 are not in contact when rotating to the second position, leaving a certain gap. It may be understood by those of ordinary skills in the art that the gap between the two through holes should be adapted to the maximum rotation angle limited by the limiting piece 123 and the height of the ring pressing assembly 110. Therefore, the present disclosure does not specifically limit a distance between the two through holes.

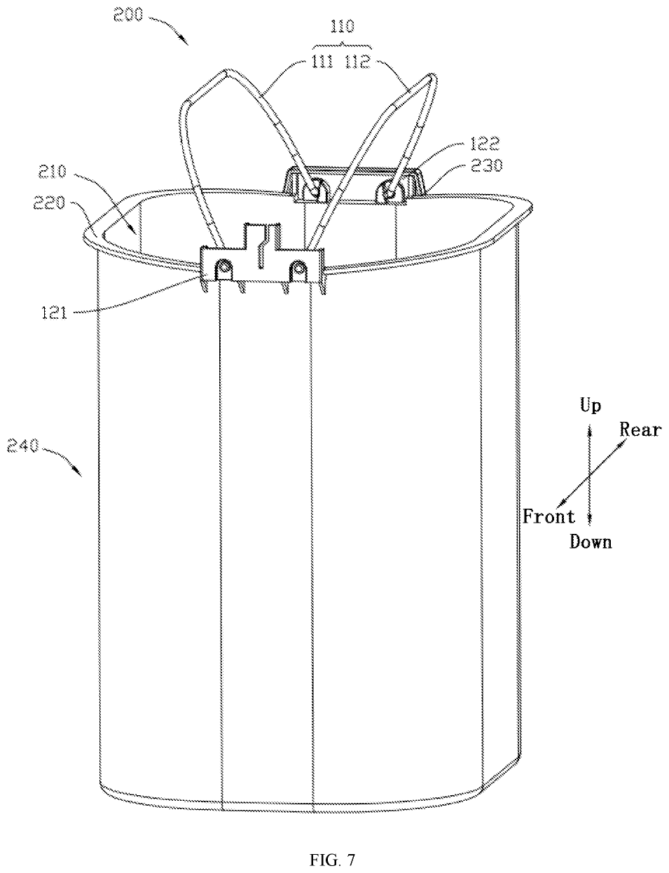

FIG. 7 shows a structural schematic diagram of the first garbage can 200 according to an embodiment in a sixth aspect of the present disclosure. The first garbage can 200 includes the sealing device 100 provided in FIG. 1, a can body 240 with an opening 210, a flange 220 arranged along the opening 210, and a protective piece 230 matched with the flange 220 and detachably connected with the connecting assembly 120.

The oblique arrangement of the first ring pressing piece 111 and the second ring pressing piece 112 changes the forcing direction. The first ring pressing piece 111 and the second ring pressing piece 112 are more easily closed towards a plane perpendicular to the opening 210 and defined by the first connecting piece 121 and the second connecting piece 122. Meanwhile, as the support opening 130 closes and becomes smaller, the first ring pressing piece 111 and the second ring pressing piece 112 rotate to the second position limited by the limiting piece 123, so as to seal the pull-rope-type garbage bag. The use of the sealing device 100 reduces the manufacturing cost of the first garbage can 200 and improves the space utilization rate of the first garbage can 200 while being convenient for users to use.

It may be understood by those of ordinary skills in the art that the sealing device 100 may be arranged at the opening 210 of the first garbage can 200 or in a position lower than the opening 210 of the first garbage can 200. In this case, the ring pressing assembly 110 is in the can body space of the first garbage can 200, and the support opening 130 formed by the first ring pressing piece 111 and the second ring pressing piece 112 is located below the plane on which the opening 210 of the first garbage can 200 is located. The ring pressing assembly 110 interacts with a side wall of the first garbage can 200 to fasten the pull-rope-type garbage bag. The first ring pressing piece 111 and the second ring pressing piece 112 may still be closed upward to the center by the pull rope of the pull-rope-type garbage bag, so as to achieve sealing.

Those of ordinary skills in the art may understand that the sealing device 100 and the opening 210 of the first garbage can 200 may be matched with each other or may not be matched with each other.

When the sealing device 100 is matched with the opening 210 of the first garbage can 200, in the initial first position, the first ring pressing piece 111 and the second ring pressing piece 112 cooperate with the flange 220 to fasten the pull-rope-type garbage bag, and the support opening 130 coincides with the opening 210. The edge of the pull-rope-type garbage bag may be folded along the ring pressing assembly 110, which is more beautiful. When the sealing device 100 is not matched with the opening 210 of the first garbage can 200, the sealing device 100 may be arranged in the first garbage can 200. Therefore, the shape of the first garbage can 200 is not specifically limited in the present disclosure, as long as the first garbage can 200 can serves the purpose of containing the garbage.

It should be noted that the connection mode between the sealing device 100 and the first garbage can 200 is not specifically limited in the present disclosure. The sealing device 100 and the first garbage can 200 may be integrally connected or movably connected.

The sealing device 100 with the rope clamping portion 124 is the embodiment in the second aspect of the present disclosure, and the sealing device 100 without the rope clamping portion is the embodiment in the first aspect of the present disclosure. Referring to FIG. 7, the garbage can provided by the embodiment in the sixth aspect of the present disclosure includes the sealing device 100 provided by the embodiment in the second aspect of the present disclosure. The garbage can further includes the rope clamping portion 124. It may be understood that the rope clamping portion 124 may be arranged on the sealing device 100 or may be matched with the sealing device 100 to arrange on the garbage can body.

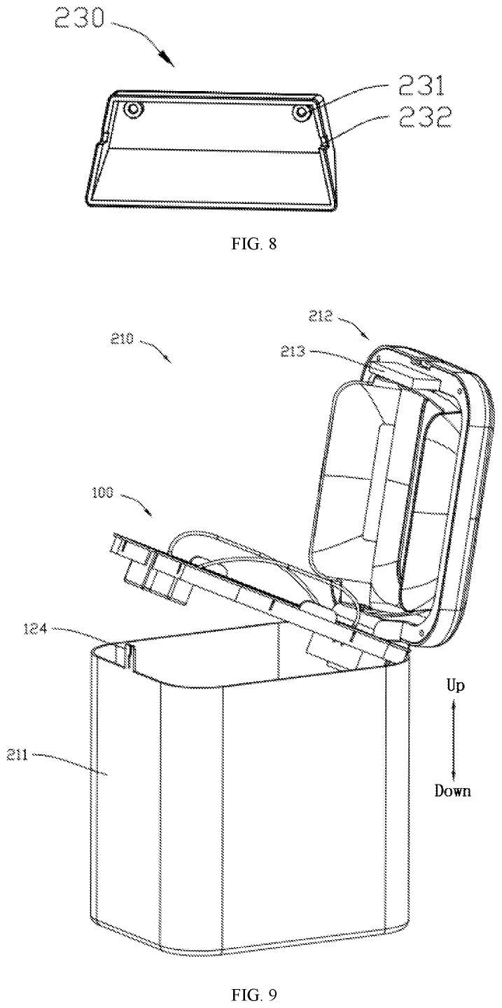

The garbage can according to the embodiment in the sixth aspect of the present disclosure is provided with a garbage can body and a protective piece matched with the flange of the garbage can body. Referring to FIG. 8, the protective piece 230 is a cover with one opened side and three closed sides, and is provided with a second groove 232 with a shape and size matching with the flange 220. Referring to FIG. 3, the second connecting piece 122 further includes a mounting piece 1223. A mounting hole 231 arranged on the protective piece 230 is matched with the mounting piece 1223 arranged on the second connecting piece 122. The protective piece 230 is detachably connected with the second connecting piece 122, serving to protect the first resetting piece 1221 and the second resetting piece 1222 and reducing the risk of damage from external impact. It may be understood that the connection mode between the protective piece 230 and the second connecting piece 122 may be in a snap-fit connection, or in a bolt connection and so on.

A garbage can body is provided according to an embodiment in a third aspect of the present disclosure, which is provided with the sealing device 100 according to the embodiment in the second aspect of the present disclosure and a first can body connected with the connecting assembly 120.

A garbage can body is provided according to an embodiment in a fourth aspect of the present disclosure, which is provided with the sealing device 100 according to the embodiment in the first aspect of the present disclosure and a second can body connected with the connecting assembly 120. The second can body is provided with the rope clamping portion 124 at a position corresponding to the connecting assembly 120, and the rope clamping portion 124 is provided with a clamping groove 1241, and the clamping groove 1241 is configured for threading the pull rope of the pull-rope-type garbage bag.

A garbage can is provided according to an embodiment in a fifth aspect of the present disclosure, which is provided with the garbage can body provided by the embodiment in the third aspect of the present disclosure or the garbage can body provided by the embodiment in the fourth aspect of the present disclosure. The garbage can includes a first can body and a first can cover body movably connected with the first can body, and the garbage can body is arranged in the first can body. The garbage can is in a combined type and is provided with an inner can. The garbage can body provided by the embodiment in the third aspect of the present disclosure or the garbage can body provided by the embodiment in the fourth aspect of the present disclosure is applied to the garbage can as an inner can body. The garbage can also includes an induction switch device for controlling the opening and closing of the first can cover body, where the induction switch device includes a driving module connected with the first can cover body, a controller connected with the driving module and a sensor connected with the controller.

The garbage can provided by the embodiment in the sixth aspect of the present disclosure is provided with the sealing device 100 provided by the embodiment in the second aspect.

Referring to FIG. 9, a garbage can is provided according to an embodiment in a seventh aspect of the present disclosure. The second garbage can 210 is provided with the sealing device 100 provided by the embodiment in the first aspect. The second garbage can 210 includes a second can body 211 and a second can cover body 212 movably connected with the second can body 211. The sealing device 100 is arranged on the second can body 211, and the rope clamping portion 124 is arranged on the second can body 211 in a position corresponding to the connecting assembly 120. The rope clamping portion 124 is provided with the clamping groove 1241, and the clamping groove 1241 is configured for threading the pull rope of the pull-rope-type garbage bag. The second garbage can 210 also includes the induction switch 213 device for controlling the opening and closing of the second can cover body 212, and the induction switch 213 device includes a driving module connected with the second can cover body 212, a controller connected with the driving module and a sensor connected with the controller.

It should be noted that the second can cover body 212 may be a structure that can be turned up and down relative to the second can body 211, or may be a structure that can be opened left and right relative to the second can body 211.

The embodiments of the present disclosure have been described in detail with reference to the accompanying drawings, but the present disclosure is not limited to the above embodiments, and various changes may be made within the knowledge of those of ordinary skills in the art without departing from the purpose of the present disclosure.

1. A sealing device applied to a garbage can, comprising:
a connecting assembly, provided with a limiting piece;
a ring pressing assembly, comprising a first ring pressing piece and a second ring pressing piece, and configured for arranging a pull-rope-type garbage bag;
the ring pressing assembly being rotatably connected with the connecting assembly; the first ring pressing piece and the second ring pressing piece being configured to rotate from a first position to a second position under an action of a pull rope of the pull-rope-type garbage bag, and the first ring pressing piece and the second ring pressing piece being both provided with a round corner at a side opposite to a rope pulling direction; and
the limiting piece, arranged on the connecting assembly, and configured for limiting a rotatable angle of the ring pressing assembly.

2. The sealing device according to claim 1, wherein, in the first position, the first ring pressing piece and the second ring pressing piece are under an action of the limiting piece, and a plane on which the first ring pressing piece is located and a plane on which the second ring pressing piece is located form a dihedral angle of less than 180 degrees.

3. The sealing device according to claim 1, wherein, in the second position, the first ring pressing piece and the second ring pressing piece are under an action of the limiting piece, and a plane on which the first ring pressing piece is located is relatively parallel to a plane on which the second ring pressing piece is located, or a plane on which the first ring pressing piece is located and a plane on which the second ring pressing piece is located form a dihedral angle of less than 90 degrees.

4. The sealing device according to claim 1, further comprising an elastic assembly arranged on the connecting assembly, wherein the elastic assembly is connected with the ring pressing assembly, and the elastic assembly is configured for driving the first ring pressing piece and the second ring pressing piece to rotate from the second position to the first position.

5. The sealing device according to claim 1, wherein a circular arc of the round corner of the ring pressing assembly is at least R80.

6. The sealing device according to claim 1, wherein the connecting assembly comprises a first connecting piece and a second connecting piece, the first connecting piece is further provided with a rope clamping portion, the rope clamping portion is provided with a clamping groove, and the clamping groove is configured for threading the pull rope of the pull-rope-type garbage bag.

7. (canceled)

8. A garbage can body, comprising the sealing device according claim 1 and a second can body connected with the connecting assembly.

9. The garbage can body according to claim 8, wherein a rope clamping portion is arranged on the second can body in a position corresponding to the connecting assembly, the rope clamping portion is provided with a clamping groove, and the clamping groove is configured for threading the pull rope of the pull-rope-type garbage bag.

10. A garbage can, comprising the garbage can body according to claim 8.

11. The garbage can according to claim 10, wherein the garbage can comprises a first can body and a first can cover body movably connected with the first can body, and the garbage can body is arranged in the first can body.

12. The garbage can according to claim 11, further comprising an induction switch device configured for controlling opening and closing of the first can cover body, wherein the induction switch device comprises a driving module connected with the first can cover body, a controller connected with the driving module and a sensor connected with the controller.

13. (canceled)

14. A garbage can, comprising the sealing device according to claim 1.

15. The garbage can according to claim 14, wherein the garbage can comprises a second can body and a second can cover body movably connected with the second can body, the sealing device is arranged on the second can body, a rope clamping portion is arranged on the second can body in a position corresponding to the connecting assembly, the rope clamping portion is provided with a clamping groove, and the clamping groove is configured for threading a pull rope of the pull-rope-type garbage bag.

16. The garbage can according to claim 15, further comprising an induction switch device configured for controlling opening and closing of the second can cover body, wherein the induction switch device comprises a driving module connected with the second can cover body, a controller connected with the driving module and a sensor connected with the controller.
